(19) United States
(12) Patent Application Publication
(10) Pub. No.: US 2026/0329479 A1
(43) Pub. Date: Oct. 22, 2026

(54) STORAGE DEVICE INCLUDING MEMORY CONTROLLER AND METHOD OF OPERATING THE MEMORY CONTROLLER

(71) Applicant: SK hynix Inc., Gyeonggi-do (KR)

(72) Inventors: Ku Ik KWON, Gyeonggi-do (KR); In Sung SONG, Gyeonggi-do (KR); Jin Won JANG, Gyeonggi-do (KR); Moon Sung CHOI, Gyeonggi-do (KR)

(21) Appl. No.: 19/358,434

(22) Filed: Oct. 15, 2025

(30) Foreign Application Priority Data
Apr. 18, 2025 (KR) 10-2025-0051016

(51) Int. Cl. G06F 3/06; G06F 12/02

(52) U.S. Cl. CPC G06F 3/0659; G06F 3/0604; G06F 3/0679; G06F 12/0253; G06F 2212/7205

(57) ABSTRACT

A storage device includes a memory device including a plurality of memory blocks and a memory controller controlling a garbage collection operation mode of the memory device. The memory controller includes: a host interface layer managing, based on a plurality of logical page numbers, a plurality of logical pages respectively mapped to the plurality of memory blocks; a counter generating a count table including counts corresponding to indices which group the plurality of logical page numbers in units of data of a specific size, and increasing, when a write command is received from a host, a count of an index corresponding to the write command and a locality garbage collection controller calculating percentage values corresponding to the indices based on the counts, and determining, based on the percentage values, the garbage collection operation mode to be a mode in which a garbage collection operation taking locality into account is performed.

### CROSS-REFERENCE TO RELATED APPLICATIONS

The present application claims priority under 35 U.S.C. § 119(a) to Korean patent application number 10-2025-0051016, filed on Apr. 18, 2025, the entire disclosure of which is incorporated herein by reference.

### BACKGROUND

### 1. Technical Field

Various embodiments of the present disclosure generally relate to a storage device, and more particularly, to a storage device including a memory controller and a method of operating the memory controller.

### 2. Related Art

A storage device is a device which stores data under the control of a host, such as a computer, smartphone, or smart pad. The storage device may include a memory device in which data is stored, and a memory controller which stores data in the memory device. The memory device may be classified as a volatile memory device or a non-volatile memory device.

The memory controller may perform a garbage collection operation to reclaim unused memory blocks. In particular, the memory controller may perform a locality garbage collection operation which takes locality into account, controlling the memory device so that data that is in use is placed close together.

However, for a memory device which performs only a locality garbage collection operation, an unnecessary locality garbage collection operation may be performed regardless of an actual workload. Therefore, it is necessary to consider the workload of the memory device to determine whether to perform the locality garbage collection operation.

### SUMMARY

Various embodiments of the present disclosure are directed to a storage device performing a locality garbage collection operation based on a workload of a memory device and a method of controlling a garbage collection operation mode of a memory device.

A storage device according to embodiments of the present disclosure may include a memory device including a plurality of memory blocks and a memory controller configured to control a garbage collection operation mode of the memory device. The memory controller may include: a host interface layer (HIL) configured to manage, based on a plurality of logical page numbers, a plurality of logical pages respectively mapped to the plurality of memory blocks; a counter configured to generate a count table including counts corresponding to indices which group the plurality of logical page numbers in units of data of a specific size, and increase, when a write command is received from a host, a count of an index corresponding to the write command; and a locality garbage collection controller configured to calculate percentage values corresponding to the indices based on the counts, and determine, based on the percentage values, the garbage collection operation mode to be a mode in which a garbage collection operation taking locality into account is performed.

In an embodiment, the locality garbage collection controller may determine, when the percentage values do not exceed a reference value, the garbage collection operation mode to be a first mode , and determine, when at least one of the percentage values exceeds the reference value, the garbage collection operation mode to be a second mode. The first mode may be a mode in which a garbage collection operation which does not take the locality into account is performed, and the second mode may be a mode in which a garbage collection operation which takes the locality into account is performed.

In an embodiment, the second mode may be an operation mode in which garbage collection is performed by excluding recently invalidated logical memory blocks from selection of victim blocks for the garbage collection operation.

In an embodiment, when the HIL receives the write command from the host, the HIL may translate a logical block address corresponding to the write command to a logical page number, and the counter may increase a count of an index corresponding to the logical page number obtained by translating the logical block address.

In an embodiment, the memory controller may further include a Flash Translation Layer (FTL), when the FTL determines that a number of memory blocks managed by the FTL remains constant, the FTL may send a mode control request to the locality garbage collection controller, and after the locality garbage collection controller receives the mode control request, the locality garbage collection controller may periodically perform a mode determination operation for determining the garbage collection operation mode to be one of the first mode and the second mode based on the percentage values.

In an embodiment, the locality garbage collection controller may perform the mode determination operation when the count table is updated.

In an embodiment, the locality garbage collection controller may periodically perform the mode determination operation according to a first reference period.

In an embodiment, the locality garbage collection controller may compare, when there is a second time period during which the memory device operates in a garbage collection operation mode different from a garbage collection operation mode of a first time period, first throughput of the memory device during the first time period with second throughput of the memory device during the second time period, and may maintain, when the first throughput is less than the second throughput, a garbage collection operation mode during a third time period after the second time period to be identical to the garbage collection operation mode of the second time period, and the second time period may follow the first time period.

In an embodiment, when the first throughput is greater than the second throughput, the locality garbage collection controller may switch the garbage collection operation mode of the third time period to be identical to the garbage collection operation mode of the first time period.

In an embodiment, the first throughput may be a Direct Memory Access (DMA) count of the memory device per unit of time during the first time period, and the second throughput may be a DMA count of the memory device per unit of time during the second time period.

In an embodiment, the locality garbage collection controller may increase the reference value when the garbage collection operation mode during the third time period is the first mode, and may decrease the reference value when the garbage collection operation mode during the third time period is the second mode.

In an embodiment, when there are the first time period and the second time period, the locality garbage collection controller may periodically perform a mode switching operation for determining the garbage collection operation mode based on the first throughput and the second throughput.

In an embodiment, the locality garbage collection controller may periodically perform the mode switching operation according to a second reference period.

A method of controlling a garbage collection operation mode of a memory device including a plurality of memory blocks may be provided according to embodiments of the present disclosure. The method may include generating a count table including counts corresponding to indices which group a plurality of logical page numbers in units of data of a specific size; increasing, when a write command is received from a host, a count of an index corresponding to the write command; calculating percentage values corresponding to the indices based on the counts; and determining, based on the percentage values, the garbage collection operation mode to be a mode in which a garbage collection operation taking locality into account is performed.

In an embodiment, calculating the percentage values may include calculating the percentage values when a number of memory blocks managed by the memory controller remains constant.

In an embodiment, determining, based on the percentage values, the garbage collection operation mode to be the mode in which the garbage collection operation taking the locality into account is performed may include: comparing the percentage values with a reference value; determining the garbage collection operation mode to be a first mode when the percentage values do not exceed the reference value; and determining the garbage collection operation mode to be a second mode when at least one of the percentage values exceeds the reference value, and the first mode may be a mode in which a garbage collection operation which does not take the locality into account is performed, and the second mode may be a mode in which a garbage collection operation which takes the locality into account is performed.

In an embodiment, the method may further include: comparing, when there is a second time period during which the memory device operates in a second garbage collection operation mode different from a first garbage collection operation mode of a first time period, first throughput of the memory device during the first time period with second throughput of the memory device during the second time period; and maintaining, when the first throughput is less than the second throughput, a garbage collection operation mode during a third time period after the second time period to be identical to the garbage collection operation mode of the second time period, and the second time period may follow the first time period.

In an embodiment, the method may further include switching, when the first throughput is greater than the second throughput, the garbage collection operation mode of the third time period to be identical to the garbage collection operation mode of the first time period.

In an embodiment, the method may further include increasing the reference value when the garbage collection operation mode during the third time period is the first mode.

In an embodiment, the method may further include decreasing the reference value when the garbage collection operation mode during the third time period is the second mode.

### BRIEF DESCRIPTION OF THE DRAWINGS

FIG. 1 is a block diagram of an electronic system according to an embodiment of the present disclosure;

FIG. 2 is a detailed block diagram illustrating a memory controller of FIG. 1, according to embodiments of the present disclosure;

FIG. 3 is a detailed block diagram illustrating a non-volatile memory device of FIG. 1, according to embodiments of the present disclosure;

FIG. 4 is a diagram illustrating an operation of a counter;

FIG. 5 is a diagram illustrating a mode determination operation of a locality garbage collection controller;

FIG. 6 is a block diagram illustrating a mode determination operation of a locality garbage collection module;

FIG. 7 is a diagram illustrating an operation of a locality garbage collection controller over time;

FIG. 8 is a diagram illustrating an operation of a locality garbage collection controller over time;

FIG. 9 is a flowchart illustrating a mode determination operation of a locality garbage collection controller;

FIG. 10 is a flowchart illustrating a mode switching operation of a locality garbage collection controller;

FIG. 11 is a block diagram illustrating a memory card system to which a storage device according to embodiments of the present disclosure is applied; and

FIG. 12 is a block diagram illustrating, as an example, a Solid State Drive (SSD) system to which a storage device according to embodiments of the present disclosure is applied.

### DETAILED DESCRIPTION

Hereinafter, embodiments according to the present disclosure are described in detail with reference to the accompanying drawings. It should be noted that in the following description, only portions necessary for understanding an operation according to the present disclosure may be described, and descriptions of other portions may be omitted in order not to obscure the subject matter of the present disclosure. In addition, the present disclosure may be embodied in other forms without being limited to embodiments described herein. However, embodiments of the present disclosure are described in detail in order for those skilled in the art to be able to readily implement the technical spirit of the present disclosure.

Terms used herein are for describing specific embodiments and are not intended to limit the disclosure. Throughout the specification, in a case where a certain portion “includes” a certain component, the portion may further include another component without excluding another component unless otherwise stated. “At least any one of X, Y, or Z” and “at least any one selected from a group consisting of X, Y, or Z” may be interpreted as X only, Y only, Z only, or any combination of two or more of X, Y, and Z (e.g., XYZ, XYY, YZ, and ZZ). Here, “and/or” includes all combinations of one or more of corresponding configurations.

Here, terms such as first and second may be used to describe various components, but these components are not limited to these terms. These terms are used to distinguish one component from another component. Therefore, a first component may refer to a second component within a range without departing from the scope disclosed herein.

In this field, some embodiments are described and illustrated in the accompanying drawings in terms of functional blocks, units, parts, and/or modules. Those skilled in the art will understand that these blocks, units, parts, and/or modules are physically implemented by electronic (or optical) circuits, such as logic circuits, discrete components, microprocessors, hard-wired circuits, memory elements, line connections, and the like, which may be formed using semiconductor-based manufacturing techniques or other manufacturing techniques. In a case where the blocks, units, parts, and/or modules are implemented by microprocessors or other similar hardware, they may be programmed and controlled using software (e.g., microcode) to perform the various functions discussed herein, and may optionally be driven by firmware and/or software.

Further, each block, unit, part, and/or module may be implemented by dedicated hardware, or by a combination of dedicated hardware performing some functions and processors (e.g., one or more programmed microprocessors and associated circuits) performing other functions. Further, each block, unit, part, and/or module of some embodiments may be physically separated into two or more interacting and separate blocks, units, parts, and/or modules without departing from the scope of the present disclosure. Further, the blocks, units, parts, and/or modules of some embodiments may be physically combined into more complex blocks, units, parts, and/or modules without departing from the scope of the present disclosure.

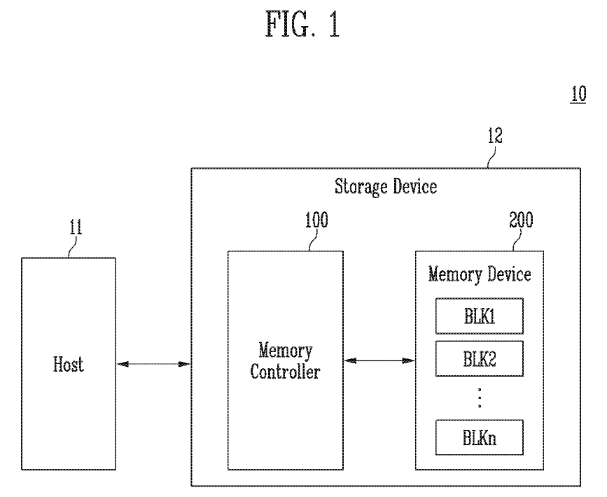

FIG. 1 is a block diagram of an electronic system 10 according to an embodiment of the present disclosure.

Referring to FIG. 1, the electronic system 10 may be a computing system configured to process various information and/or store processed information as data. In some embodiments, the electronic system 10 may be implemented as a personal computer (PC), notebook, laptop, server, workstation, tablet PC, smartphone, digital camera, dashcam, or the like.

The electronic system 10 may include a host 11 and a storage device 12. The host 11 may control various operations of the electronic system 10. More specifically, the host 11 may control the operations of other components constituting the electronic system 10. The host 11 may be implemented as a general purpose processor, a dedicated processor, a central processing unit (CPU), or an application processor (AP).

The host 11 may communicate with the storage device 12. For example, the host 11 may request that the storage device 12 perform a program operation, a read operation, an erase operation, or the like. The host 11 may transfer to the storage device 12 a host request, data, and a logical address for the program operation of the storage device 12. The host 11 may transfer to the storage device 12 a host request and a logical address for the read operation of the storage device 12.

The storage device 12 may store data. For example, the storage device 12 may store the data under the control of the host 11. In some embodiments, storage device 12 may include at least one of a Solid State Device (SSD), embedded memory, or removable external memory.

When the storage device 12 is an SSD, the storage device 12 may be a device which conforms to a Non-Volatile Memory express (NVMe) standard. When the storage device 12 is embedded memory or removable external memory, the storage device 12 may be a device which conforms to a Universal Flash Storage (UFS) or embedded Multi-Media Card (eMMC) standard. The host 11 and the storage device 12 may each generate packets based on an adopted standard protocol and transfer the generated packets to each other.

The storage device 12 may include a memory controller 100 and a memory device 200. The memory controller 100 may control an operation of the storage device 12. For example, the memory controller 100 may control the operation of the storage device 12 in accordance with an internal policy or in response to a request from the host 11. The memory controller 100 may store data in the memory device 200 or read data stored in the memory device 200 in accordance with an internal policy or in response to a request from the host 11.

In response to a host request corresponding to a program operation received from the host 11, the memory controller 100 may generate a program command and provide the generated program command to the memory device 200. The memory controller 100 may, in response to a host request corresponding to a read operation received from the host 11, generate a command and provide the generated command to the memory device 200. The memory controller 100 may transfer the data read from the memory device 200 to the host 11.

The memory device 200 may store the data under the control of the memory controller 100. The memory device 200 may include a plurality of memory blocks BLK1 to BLKn. Each of the plurality of memory blocks BLK1 to BLKn may include a plurality of memory cells, and the plurality of memory cells may form a plurality of strings or a plurality of pages. In some embodiments, a page may be a unit for storing data in the memory device 200, or for reading data stored in the memory device 200. A memory block may be a unit for erasing data stored in the memory device 200.

The memory device 200 may move or copy data within the memory device 200 to perform various functions. For example, the memory device 200 may move or copy data stored in a first memory block to a second memory block to perform at least one of a garbage collection operation, a read reclaim operation, a read refresh operation, a wear leveling operation, or an over-provisioning operation.

The memory device 200 may perform a garbage collection operation or a locality garbage collection operation.

The garbage collection operation may involve copying valid data included in a bad block among memory blocks to a free block among the memory blocks, and erasing invalid data included in the bad block.

The locality garbage collection operation may be a garbage collection operation which considers (for example, implements operations based on determination of) locality. More specifically, the locality garbage collection operation may presume that logical blocks which have been recently (for example, within a predetermined time span) invalidated are likely to have locality, and may perform garbage collection by excluding these blocks from the selection of victim blocks for the garbage collection operation. In an example, the locality garbage collection operation may exclude most of the recently invalidated blocks with predetermined exceptions for some of the recently invalidated blocks (i.e., performing garbage collection for some blocks despite having locality).

When the memory device 200 is determined (or programmed, instructed) to perform a locality garbage collection operation during the fabrication of the conventional storage device 12, the memory device 200 might not be able to perform a normal garbage collection operation which does not take locality into account.

Accordingly, the memory device 200 which performs a locality garbage collection operation may only perform locality garbage collection operations regardless of the actual workload. For example, when the memory device 200 is programmed to perform a locality garbage collection operation, it may be necessary to perform a locality garbage collection operation even in situations where the memory device 200 performs an operation of writing data to random addresses, making a locality garbage collection operation unnecessary. This unnecessary garbage collection may increase a Write Amplification Factor (WAF).

Although parameters for a locality garbage collection operation (e.g., the number of logical blocks excluded from the victim selection) may be tuned to take into account the actual workload of memory device 200, there may be limitations which prevent it from supporting all of the various workloads.

That is, optimal efficiency of the storage device 12 may require determining whether or not to perform a locality garbage collection operation by taking into account the actual workload of the memory device 200.

The memory device 200 may be NAND flash memory, but the scope of the present disclosure is not limited thereto. The memory device 200 may be one of a variety of storage devices which may retain stored data even when the power supply is interrupted, such as a Phase-change Random Access Memory (PRAM), Magnetic Random Access Memory (MRAM), Resistive Random Access Memory (RRAM), and Ferroelectric Random Access Memory (FRAM) device.

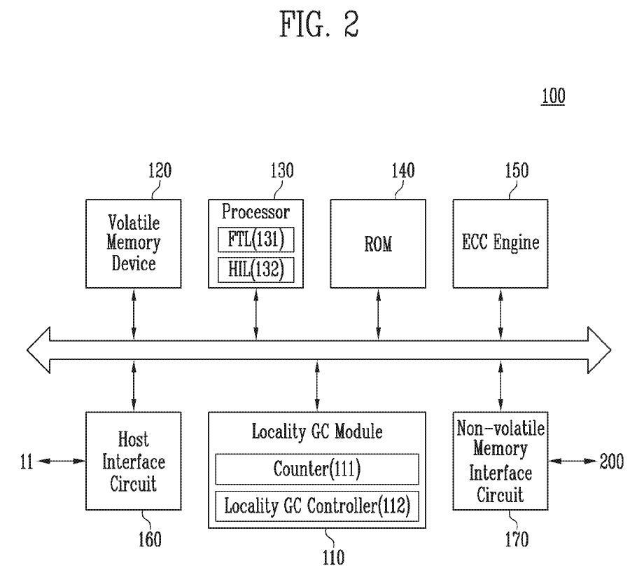

FIG. 2 is a detailed block diagram illustrating the memory controller 100 of FIG. 1, according to embodiments of the present disclosure.

Referring to FIGS. 1 and 2, the memory controller 100 may communicate with the host 11 and a non-volatile memory device (200). The memory controller 100 may include a locality garbage collection (GC) module 110, a volatile memory device 120, a processor 130, Read Only Memory (ROM) 140, an Error Correction Code (ECC) engine 150, a host interface circuit 160, and a non-volatile memory interface circuit 170.

The locality garbage collection module 110 may include a counter 111 and a locality garbage collection (GC) controller 112. In some embodiments, the locality garbage collection module 110 may be implemented as Firmware. For example, the non-volatile memory device 200 may store instructions corresponding to the locality garbage collection module 110. The processor 130 may load the instructions from the non-volatile memory device 200 into the volatile memory device 120. By executing the loaded instructions, the processor 130 may operate the locality garbage collection module 110.

The locality garbage collection module 110 may control an operation mode of the memory device 200 based on a write command received from the host 11. The operation mode may include a first mode in which a garbage collection operation which does not take locality into account is performed and a second mode in which a locality garbage collection operation which takes locality into account is performed.

Whenever a write command is received from the host 11, a Host Interface Layer (HIL) 132 of the processor 130 may translate the received write command to a corresponding logical page number.

The counter 111 may be implemented as a hardware circuit and may manage the logical page number in units of data of a specific size. For example, the counter 111 may generate a count table and store the count table in a memory region, such as the volatile memory device 120. The count table may group logical page numbers in units of 1 GB. Index 0 of the count table may correspond to logical page numbers corresponding to 0 GB to 1 GB, and index 1 may correspond to logical page numbers corresponding to 1 GB to 2 GB. The counter 111 may increase a count of an index corresponding to the logical page number which is obtained by translating the write command.

The locality garbage collection controller 112 may perform a mode determination operation and a mode switching operation. The mode determination operation may be an operation to determine the operation mode of the memory device 200 to be one of the first mode and the second mode based on the count table, and the mode switching operation may be an operation to maintain the operation mode of the memory device 200 as the previous operation mode, or to switch the operation mode to a different operation mode.

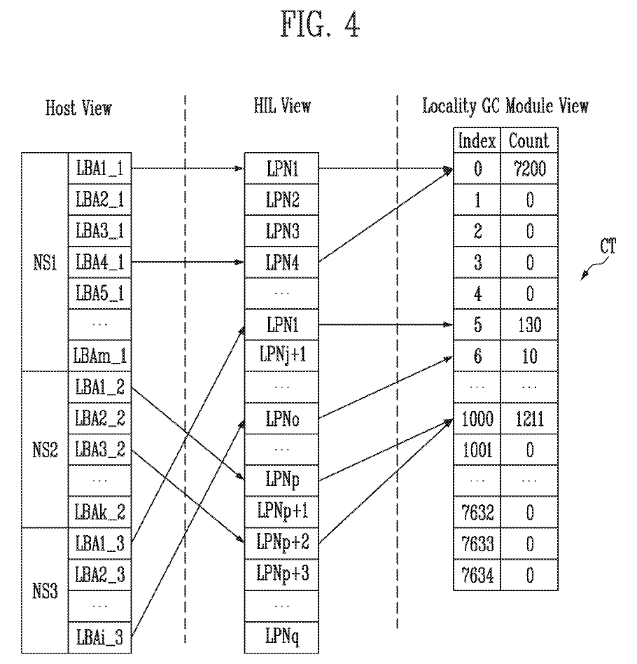

A more detailed description of the counter 111 and the locality garbage collection controller 112 will be described below with reference to FIGS. 4-10.

The volatile memory device 120 may be used as main memory, cache memory, or operational memory of the memory controller 100. For example, the volatile memory device 120 may be implemented as Static Random Access Memory (SRAM), Dynamic Random Access Memory (DRAM), or the like.

The processor 130 may control various operations of the memory controller 100. The processor 130 may execute firmware to control the operation of the memory controller 100. The processor 130 may execute (run) firmware loaded into the volatile memory device 120 at boot time to control various operations of the memory controller 100 and perform logical operations.

The firmware is a program which runs within the storage device 12 and may include various functional layers. For example, the firmware may include one or more of: a Flash Translation Layer (FTL) 131 which functions to translate between a logical address requested by the host 11 to the storage device 12 and a physical address of the memory device 200; the Host Interface Layer (HIL) 132 which functions to interpret and deliver a command requested by the host 11 to the memory device 200 to the FTL 131; and a Flash Interface Layer (FIL) which delivers a command directed by the FTL 131 to the memory device 200.

The ROM 140 may be used as read-only memory which stores information used for an operation of the memory controller 100. The ECC engine 150 may detect and correct errors in data read from the non-volatile memory device 200. For example, the ECC engine 150 may have a predetermined level of error correction capability. The ECC engine 150 may treat data having an error level (e.g., the number of flipped bits) which exceeds the error correction capability as uncorrectable data.

The memory controller 100 may communicate with the host 11 via the host interface circuit 160. In some embodiments, the host interface circuit 160 may be implemented based on at least one of various interfaces, such as a Serial Advanced Technology Attachment (SATA) interface, a Peripheral Component Interconnect Express (PCIe) interface, a Serial Attached Small Computer System Interface (SAS), an embedded MultiMedia Card (eMMC) interface, a Universal Flash Storage (UFS) interface, and the like.

The memory controller 100 may communicate with the non-volatile memory device 200 via the non-volatile memory interface circuit 170. In some embodiments, the non-volatile memory interface circuit 170 may be implemented based on a NAND Flash interface, such as Toggle, Open NAND Flash Interface (ONFI), or the like.

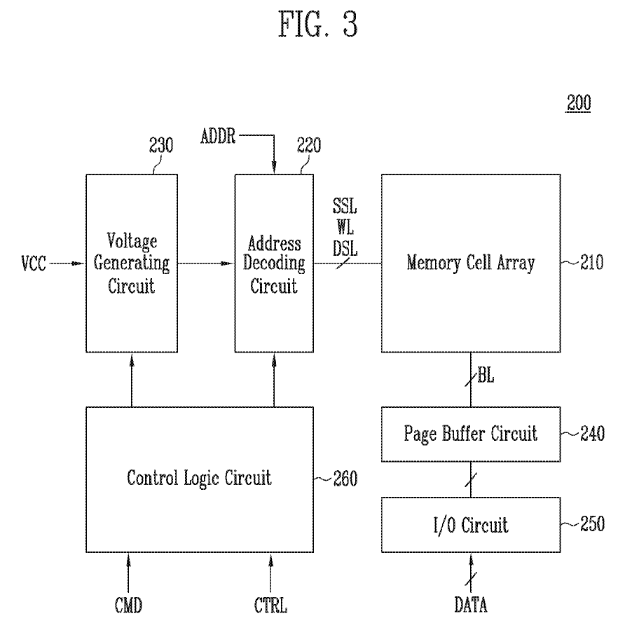

FIG. 3 is a detailed block diagram illustrating the non-volatile memory device 200 of FIG. 1, according to embodiments of the present disclosure.

Referring to FIG. 3, the non-volatile memory device 200 may include a memory cell array 210, an address decoding circuit 220, a voltage generating circuit 230, a page buffer circuit 240, an input/output circuit 250, and a control logic circuit 260.

In some embodiments, the non-volatile memory device 200 may be a non-volatile memory device based on NAND flash memory. However, the scope of the present disclosure is not limited thereto, and the non-volatile memory device 200 may be one of various types of memory devices, such as DRAM, SRAM, phase-change random access memory (PRAM), magnetoresistive random access memory (MRAM), resistive random access memory (RRAM), ferroelectric random access memory (FRAM), and the like.

The memory cell array 210 may include a plurality of memory blocks. The plurality of memory blocks may be the plurality of memory blocks BLK1 to BLKn described with reference to FIG. 1. Each of the plurality of memory blocks may include a plurality of cell strings. Each of the plurality of cell strings may be coupled to the address decoding circuit 220 via row lines and to the page buffer circuit 240 via bit lines BL. The low lines may include drain select lines DSL, word lines WL, and source select lines SSL.

Each of the plurality of cell strings may include a plurality of memory cells. The plurality of memory cells may respectively correspond to a plurality of cell transistors coupled in series between the bit lines BL and the select lines. The plurality of cell transistors may be coupled to the drain select lines DSL, the word lines WL, and the source select lines SSL.

In embodiments, the address decoding circuit 220, the voltage generating circuit 230, the page buffer circuit 240, and the input/output circuit 250 may be collectively referred to as a peripheral circuit. The peripheral circuit may drive the memory cell array 210 under the control of the control logic circuit 260. The peripheral circuit may drive the memory cell array 210 to perform a program operation, a read operation, and an erase operation.

The address decoding circuit 220 may be coupled to the memory cell array 210 and via the row lines. The address decoding circuit 220 may receive an address ADDR from the control logic circuit 260. The address decoding circuit 220 may decode a block address of the received address ADDR. The address decoding circuit 220 may select at least one memory block of the plurality of memory blocks based on the decoded block address.

The address decoding circuit 220 may decode a row address of the received address ADDR. The address decoding circuit 220 may select at least one word line of the word lines of the selected memory block based on the decoded row address. In embodiments, the address decoding circuit 220 may decode a column address of the received address ADDR. The address decoding circuit 220 may couple the input/output circuit 250 and the memory cell array 210 according to the decoded column address.

The voltage generating circuit 230 may generate various voltages used for the non-volatile memory device 200 to operate. For example, the voltage generating circuit 230 may generate various voltages, such as a plurality of program voltages, a plurality of pass voltages, a plurality of verify voltages, a plurality of selected read voltages, a plurality of unselected read voltages, a plurality of erase voltages, and a plurality of erase verify voltages, based on a power voltage VCC.

The page buffer circuit 240 may be coupled to the memory cell array 210 via the bit lines BL. The page buffer circuit 240 may read data stored in the memory cell array 210 by detecting voltage changes on the bit lines BL, and may temporarily store the read data. The page buffer circuit 240 may receive data from the input/output circuit 250, and may store data in the memory cell array 210 by controlling the bit lines BL based on the received data.

The input/output circuit 250 may transfer and receive data DATA to and from an external device (e.g., a memory controller). For example, the input/output circuit 250 may receive the data DATA from an external device and deliver the received data DATA to the page buffer circuit 240. The input/output circuit 250 may receive the data DATA from the page buffer circuit 240 and deliver the received data DATA to the external device.

The control logic circuit 260 may control various operations of the non-volatile memory device 200. For example, the control logic circuit 260 may receive a command CMD and the address ADDR from an external device (e.g., a memory controller) and generate control signals in response to the command CMD and the address ADDR to control peripheral circuits.

FIG. 4 is a diagram illustrating an operation of the counter 111.

In FIG. 4, an operation is described in which the counter 111 of FIG. 2 groups and manages the logical page numbers, which are obtained by translating the write command, in units of data of a specific size when the write command is received from the host 11.

The host 11 may write or read data to or from the storage device 12 based on a plurality of namespaces. A namespace may be a unit for logically dividing a data storage space of the storage device 12. Each of the plurality of namespaces may include a plurality of logical block addresses.

Referring to FIG. 4, the host 11 (see Host View section of FIG. 4) may manage the data storage space of the storage device 12 based on first to third namespaces NS1 to NS3. The first namespace NS1 may include first to m-th logical block addresses LBA1_1 to LBAm_1, the second namespace NS2 may include first to k-th logical block addresses LBA1_2 to LBAk_2, and the third namespace NS3 may include first to i-th logical block addresses LBA1_3 to LBAi_3. m, k, and i are natural numbers greater than 1.

Upon receiving the write command from the host 11, the HIL 132 (see HIL View section of FIG. 4) of the processor 130 may translate the logical block address corresponding to the write command to a Logical Page Number (LPN) managed by the memory device 200. The memory device 200 may write data to a location corresponding to the logical page number.

The HIL 132 may manage the data storage space of the memory device 200 based on first to q-th logical page numbers LPN1 to LPNq. j, o, p, and q are natural numbers greater than 1, o may be greater than j, p may be greater than o, and q may be greater than p.

The HIL 132 may manage a plurality of logical pages based on the first to q-th logical page numbers LPN1 to LPNq. Each of the plurality of memory blocks may include the plurality of logical pages. A logical page is a unit used to read or write data in a logical addressing space, and one logical page may be mapped to a physical memory block.

The counter 111 (see Locality GC Module View section of FIG. 4) may manage the logical page numbers managed by the HIL 132 in units of data of a specific size. For example, the counter 111 may generate a count table CT which groups logical page numbers in units of 1 GB. Index 0 of the count table CT may group logical page numbers corresponding to 0 GB to 1 GB, and index 1 may group logical page numbers corresponding to 1 GB to 2 GB. When the HIL 132 translates the logical block address corresponding to the write command to the logical page number, the counter 111 may increase a count of an index corresponding to the logical page number.

Hereinafter, with reference to FIG. 4, operations of the HIL 132 of the processor 130 and the counter 111 of the locality garbage collection module 110 when the write command is received from the host 11 are described.

Referring to FIG. 4, when a write command corresponding to the first logical block address LBA1_1 is received from the host 11, the HIL 132 may translate the first logical block address LBA1_1 to the first logical page number LPN1.

Similarly, the arrows between a host view and a HIL 132 view may indicate operations in which the HIL 132 translates a logical block address corresponding to a write command into a logical page number when the write command is received from the host 11.

Referring to FIG. 4, the size of the logical page is 512 B, and the counter 111 may group the logical page numbers in units of 1 GB. The counter 111 may increase a count of index 0 when a write command corresponding to the first logical page number LPN1 is received. The counter 111 may increase a count of index 0 when a write command corresponding to the fourth logical page number LPN4 is received.

Similarly, the arrows between the HIL 132 view and a locality garbage collection module view may indicate an operation of increasing a count of an index corresponding to the logical page number.

Referring to the count table CT in FIG. 4, the count of index 0 may be 7200, a count of index 5 may be 130, a count of index 6 may be 10, and a count of index 1000 may be 1211.

In FIG. 4, the counter 111 groups logical page numbers in units of 1 GB, but the present disclosure is not limited thereto, and according to embodiments, the counter 111 may group logical page numbers in units of data of various sizes.

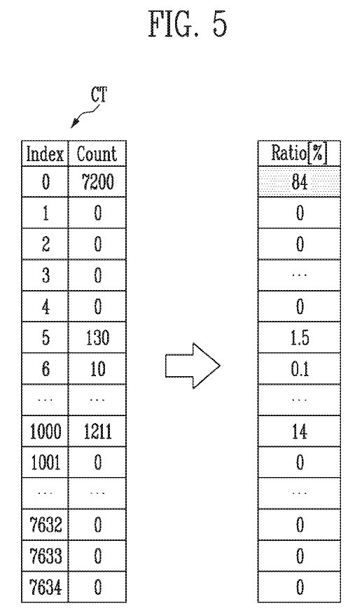

FIG. 5 is a diagram illustrating the mode determination operation of the locality garbage collection controller 112.

In FIG. 5, the mode determination operation performed by the locality garbage collection controller 112 of FIG. 2 is described.

The locality garbage collection controller 112 may initiate the mode determination operation of a mode control operation based on receiving a mode control request from the FTL 131 of the processor 130. The mode control request may serve as an initiation signal to request that the locality garbage collection controller 112 continue to perform the mode control operation.

The FTL 131 may send the mode control request to the locality garbage collection controller 112 when the FTL 131 determines that the number of memory blocks managed by the FTL 131 remains constant.

For example, the FTL 131 may send the mode control request to the locality garbage collection controller 112 when the number of allocated memory blocks remains constant, or when the number of memory blocks to which data is written remains constant.

The locality garbage collection controller 112 might not perform the mode control operation until the locality garbage collection controller 112 receives the mode control request. After receiving the mode control request, the locality garbage collection controller 112 may periodically perform the mode control operation.

That is, after receiving the mode control request, the locality garbage collection controller 112 may periodically perform the mode determination operation and the mode switching operation.

In embodiments, upon receiving the mode control request, the locality garbage collection controller 112 may perform the mode determination operation first in the mode control operation. Hereinafter, the mode determination operation of the locality garbage collection controller 112 is described below.

The locality garbage collection controller 112 may calculate a percentage value for each index based on the count in the count table CT. When at least one of the plurality of percentage values exceeds a reference value, the locality garbage collection controller 112 may determine the operation mode of the memory device 200 to be the second mode. When none of the plurality of percentage values exceed the reference value, the locality garbage collection controller 112 may determine the operation mode of the memory device 200 to be the first mode.

That is, the locality garbage collection controller 112 may determine that when at least one of the plurality of percentage values exceeds the reference value, it is necessary to (e.g., issue or initiate an instruction to) perform a garbage collection operation considering the locality of the memory device 200, and when none of the plurality of percentage values exceeds the reference value, it is not necessary to perform a garbage collection operation considering the locality of the memory device 200.

Referring to FIG. 5, when the reference value is, by way of example, ‘30’, the locality garbage collection controller 112 may control the memory device 200 to operate in the second mode because the percentage value of index 0 is ‘84’.

Although the locality garbage collection controller 112 is described herein as determining the operation mode of the memory device 200 by comparing the plurality of percentage values to the reference value, the present disclosure is not limited thereto. According to embodiments, the locality garbage collection controller 112 may determine the operation mode of the memory device 200 by comparing the largest value of the plurality of percentage values to the reference value, comparing the variance value of the plurality of percentage values to a reference value, or comparing the average value of the plurality of percentage values to a reference value.

In embodiments, the locality garbage collection controller 112 may determine the operation mode of the memory device 200 each time the count table CT is updated. For example, the locality garbage collection controller 112 may calculate a percentage value for each index each time the count table CT is updated, and determine the operation mode of the memory device 200 based on the calculated percentage value.

However, the present disclosure is not limited thereto, and according to embodiments, the locality garbage collection controller 112 may periodically determine the operation mode of the memory device 200 based on a first reference period. The first reference period may be determined by the host 11.

In embodiments, when the locality garbage collection controller 112 performs the mode determination operation for the first time after receiving the mode control request, the reference value may be a value received by the host 11, stored in the memory device 200, or stored in the ROM 140 shown in FIG. 2.

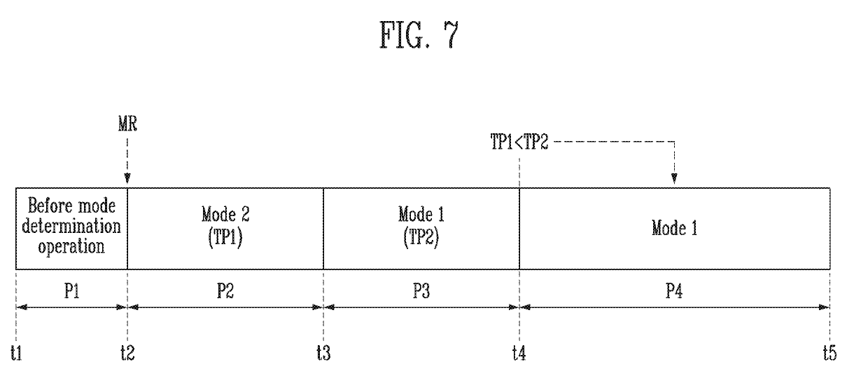

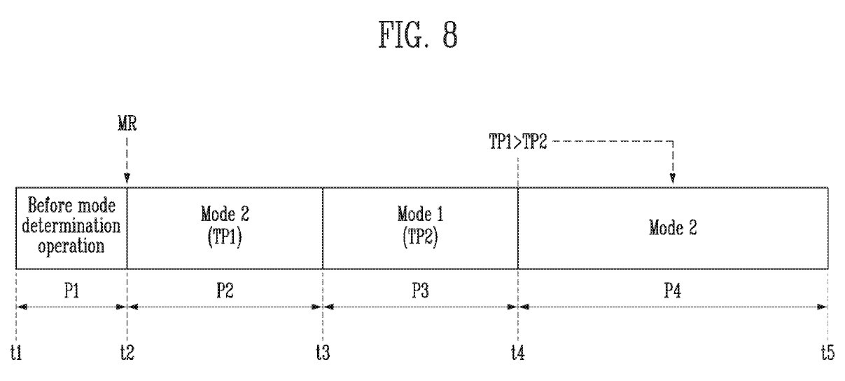

The locality garbage collection controller 112 may change the reference value when performing the mode switching operation. The mode switching operation of the locality garbage collection controller 112 will be described below with reference to FIGS. 7 and 8.

As described with reference to FIG. 5, based on the count table CT generated by the counter 111 by grouping logical page numbers in units of 1 GB, the locality garbage collection controller 112 may determine whether to perform a locality garbage collection operation. Accordingly, whether to perform a locality garbage collection operation may be determined by taking into account the locality according to the workload of the storage device 12.

Further, as the locality garbage collection controller 112 periodically performs the mode determination operation after receiving the mode control request, the operation mode of the memory device 200 might not be fixed as one of the first mode and the second mode, but may be dynamically determined to be the first mode or the second mode depending on the workload of the storage device 12.

Accordingly, an unnecessary locality garbage collection operation might not be performed, and the efficiency of the garbage collection operation may be increased.

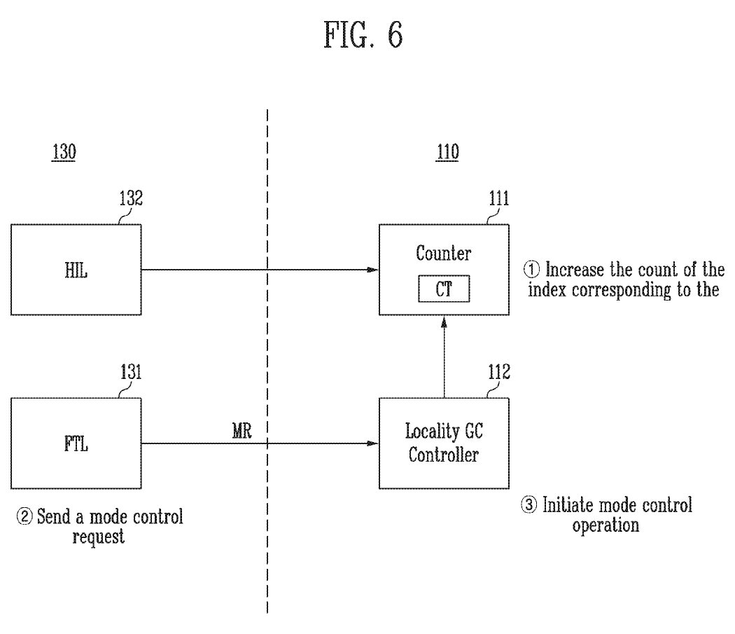

FIG. 6 is a block diagram illustrating the mode determination operation of the locality garbage collection module 110.

Referring to FIGS. 2 and 6, the locality garbage collection controller 112 may initiate the mode control operation when a mode control request MR is received from the FTL 131.

For convenience of description, only the descriptions necessary for the mode determination operation related to the FTL 131 and the HIL 132 are provided. However, the FTL 131 and the HIL 132 may also perform different operations in addition to those described with reference to FIG. 6.

The counter 111 may manage the logical page numbers managed by the HIL 132 in units of data of a specific size. The counter 111 may generate the count table CT which groups the logical page numbers in units of a specific size.

In operation ①, when the HIL 132 translates a logical block address corresponding to a write command received from a host to a logical page number, the counter 111 may increase a count of an index corresponding to the logical page number obtained by translating the logical block address.①

In operation ②, the FTL 131 may send the mode control request MR to the locality garbage collection controller 112 when the FTL 131 determines that the number of memory blocks managed by the FTL 131 remains constant.

In operation ③, the locality garbage collection controller 112 may initiate the mode control operation based on receiving the mode control request MR from the FTL 131. In embodiments, when the locality garbage collection controller 112 initiates the mode control operation, the locality garbage collection controller 112 may first perform the mode determination operation for determining the operation mode of the memory device 200 to be the first mode or the second mode based on a count in the count table CT.

FIG. 7 is a diagram illustrating an operation of the locality garbage collection controller 112 over time.

In FIG. 7, the operation of the locality garbage collection controller 112 during first to fourth time periods P1 to P4 is illustrated.

The first time period P1 corresponds to a period prior to receiving the mode control request MR, during which the locality garbage collection controller 112 might not perform the mode determination operation. However, during the first time period P1, when the HIL 132 of FIG. 6 translates a logical block address corresponding to a write command received from a host into a logical page number, the counter 111 may increase a count of an index corresponding to the logical page number obtained by translating the logical block address.

Upon receiving the mode control request MR from the FTL 131 at a time point t2, the locality garbage collection controller 112 may perform the mode determination operation.

During the second time period P2 between the time point t2 and a time point t3, the locality garbage collection controller 112 may determine the operation mode of the memory device 200 to be the second mode. The second time period P2 may follow the first time period P1.

In embodiments, the second time period P2 may be a period during which the memory device 200 operates in the second mode based on the locality garbage collection controller 112 determining the operation mode of the memory device 200 to be the second mode at the time point t2.

In other embodiments, the second time period P2 may be a repeated period during which the memory device 200 operates in the second mode for a time period shorter than the second time period P2 based on the locality garbage collection controller 112 periodically determining the operation mode of the memory device 200 to be the second mode.

During the third time period P3 between the time point t3 and a time point t4, the locality garbage collection controller 112 may determine the operation mode of the memory device 200 to be the first mode. The third time period P3 may follow the second time period P2.

In embodiments, the third time period P3 may be a period during which the memory device 200 operates in the first mode based on the locality garbage collection controller 112 determining the operation mode of the memory device 200 to be the first mode at the time point t3.

In other embodiments, the third time period P3 may be a repeated period during which the memory device 200 operates in the first mode for a time period shorter than the third time period P3 based on the locality garbage collection controller 112 periodically determining the operation mode of the memory device 200 to be the first mode.

At the time point t4, the locality garbage collection controller 112 may perform the mode switching operation. The mode switching operation may be an operation for determining whether to maintain the previous mode or switch to the other mode by comparing the throughput during each period when there are a period during which the memory device 200 operates in the first mode and a period during which the memory device 200 operates in the second mode.

In embodiments, the locality garbage collection controller 112 may compare a first throughput TP1 of the memory device 200 during the second time period P2 with a second throughput TP2 of the memory device 200 during the third time period P3.

When the second throughput TP2 is greater than the first throughput TP1, the locality garbage collection controller 112 may maintain the operation mode of the memory device 200 during the fourth time period P4 after the time point t4 as the previous mode (i.e., the first mode during the third time period P3). The fourth time period P4 may follow the third time period P3.

That is, the locality garbage collection controller 112 may determine that it is unnecessary to perform garbage collection which takes the locality into account because the throughput of the memory device 200 during the third time period P3 during which garbage collection is performed without taking the locality into account is greater than the throughput of the memory device 200 during the second time period P2 during which garbage collection is performed by taking the locality into account.

Further, when the second throughput TP2 is greater than the first throughput TP1, the locality garbage collection controller 112 may increase the reference value after the time point t4. For example, when the reference value before the time point t4 is ‘30’, the reference value after the time point t4 may be ‘40’. The locality garbage collection controller 112 may determine the operation mode of the memory device 200 based on the increased reference value when performing the mode determination operation after the time point t4.

In embodiments, the locality garbage collection controller 112 may maintain the operation mode of the memory device 200 as the first mode during the fourth time period P4 after the time point t4, when the amount of data transferred from the memory device 200 to the host 11 per unit of time during the second time period P2 is less than the amount of data transferred from the memory device 200 to the host 11 per unit of time during the third time period P3.

For example, when a Direct Memory Access (DMA) count per unit of time during the second time period P2 is less than a DMA count per unit of time during the third time period P3, the operation mode of the memory device 200 may be maintained as the first mode during the fourth time period P4 after the time point t4.

In embodiments, the fourth time period P4 may be a period during which the memory device 200 operates in the first mode based on the locality garbage collection controller 112 maintaining the operation mode of the memory device 200 as the first mode at the time point t4.

In other embodiments, the fourth time period P4 may be a repeated period during which the memory device 200 operates in the first mode for a time period shorter than the fourth time period P4 based on the locality garbage collection controller 112 maintaining the operation mode of the memory device 200 as the first mode at the time point t4 and then periodically determining the operation mode of the memory device 200 to be the first mode.

That is, after the locality garbage collection controller 112 performs the mode switching operation at the time point t4, the locality garbage collection controller 112 may periodically perform the mode determination operation during a period between the time point t4 and a time point t5.

Referring to FIG. 7, it is shown that the locality garbage collection controller 112 performs the mode switching operation at the time point t4, but this is merely one of embodiments of the present disclosure. In embodiments, the locality garbage collection controller 112 may perform the mode switching operation at at least one time point in the third time period P3 (i.e., prior to the end of the third time period P3) and determine to maintain the operation mode as the first mode.

FIG. 8 is a diagram illustrating an operation of the locality garbage collection controller 112 over time.

In FIG. 8, the operation of the locality garbage collection controller 112 during the first to fourth time periods P1 to P4 is illustrated.

The first to third time periods P1 to P3 of FIG. 8 are similar to the first to third time periods P1 to P3 of FIG. 7, and thus repetitive descriptions are omitted.

At the time point t4, the locality garbage collection controller 112 may perform the mode switching operation. In embodiments, at the time point t4, the locality garbage collection controller 112 may compare the first throughput TP1 of the memory device 200 during the second time period P2 with the second throughput TP2 of the memory device 200 during the third time period P3.

When the second throughput TP2 is less than the first throughput TP1, the locality garbage collection controller 112 may switch the operation mode of the memory device 200 during the fourth time period P4 after the time point t4 to the second mode which is different from the previous mode (i.e., the first mode during the third time period P3).

That is, the locality garbage collection controller 112 may determine that it is necessary to perform garbage collection which takes the locality into account because the throughput of the memory device 200 during the third time period P3 during which garbage collection is performed without taking the locality into account is less than the throughput of the memory device 200 during the second time period P2 during which garbage collection is performed by taking the locality into account.

Further, when the second throughput TP2 is less than the first throughput TP1, the locality garbage collection controller 112 may decrease the reference value after the time point t4. For example, when the reference value before the time point t4 is ‘30’, the reference value after the time point t4 may be ‘20’. The locality garbage collection controller 112 may determine the operation mode of the memory device 200 based on the decreased reference value when performing the mode determination operation after the time point t4.

In embodiments, the locality garbage collection controller 112 may switch the operation mode of the memory device 200 to the second mode during the fourth time period P4 after the time point t4, when the amount of data transferred from the memory device 200 to the host 11 per unit of time during the second time period P2 is greater than the amount of data transferred from the memory device 200 to the host 11 per unit of time during the third time period P3.

For example, when a Direct Memory Access (DMA) count per unit of time during the second time period P2 is greater than a DMA count per unit of time during the third time period P3, the operation mode of the memory device 200 may be switched to the second mode during the fourth time period P4 after the time point t4.

In embodiments, the fourth time period P4 may be a period during which the memory device 200 operates in the second mode based on the locality garbage collection controller 112 switching the operation mode of the memory device 200 to the second mode at the time point t4.

In other embodiments, the fourth time period P4 may be a repeated period during which the memory device 200 operates in the second mode for a time period shorter than the fourth time period P4 based on the locality garbage collection controller 112 switching the operation mode of the memory device 200 to the second mode at the time point t4 and then periodically determining the operation mode of the memory device 200 to be the second mode.

That is, after the locality garbage collection controller 112 performs the mode switching operation at the time point t4, the locality garbage collection controller 112 may periodically perform the mode determination operation during a period between the time point t4 and the time point t5.

Referring to FIG. 8, it is shown that the locality garbage collection controller 112 performs the mode switching operation at the time point t4, but this is merely one of embodiments of the present disclosure. In embodiments, the locality garbage collection controller 112 may perform the mode switching operation at at least one time point in the third time period P3 and determine to maintain the operation mode as the first mode. The locality garbage collection controller 112 may perform the mode switching operation at multiple time points in the third time period P3 and may switch between operation modes multiple times (for example, based on performance of the storage device 12 according to workload).

The first to fourth time periods P1 to P4 have been described with reference to FIGS. 7 and 8, but the length of each time period is not limited to the embodiments shown in FIGS. 7 and 8 and may be varied according to embodiments of the present disclosure.

Also, in FIGS. 7 and 8, it is shown that the memory device 200 operates in the second mode during the second time period P2 and the memory device 200 operates in the first mode during the third time period P3, but the present disclosure is not limited thereto, and the memory device 200 may operate in the first mode during the second time period P2 and in the second mode during the third time period P3.

As described with reference to FIGS. 7 and 8, the locality garbage collection controller 112 may determine whether to maintain the previous operation mode or to switch to a different operation mode based on throughput. Accordingly, whether to perform a locality garbage collection operation may be determined by taking into account the performance of the storage device 12 according to the workload.

Further, as the locality garbage collection controller 112 changes the reference value for the mode determination operation based on the throughput, the workload may be appropriately reflected in the mode determination operation. Accordingly, an unnecessary locality garbage collection operation might not be performed, and the efficiency of the garbage collection operation may be increased.

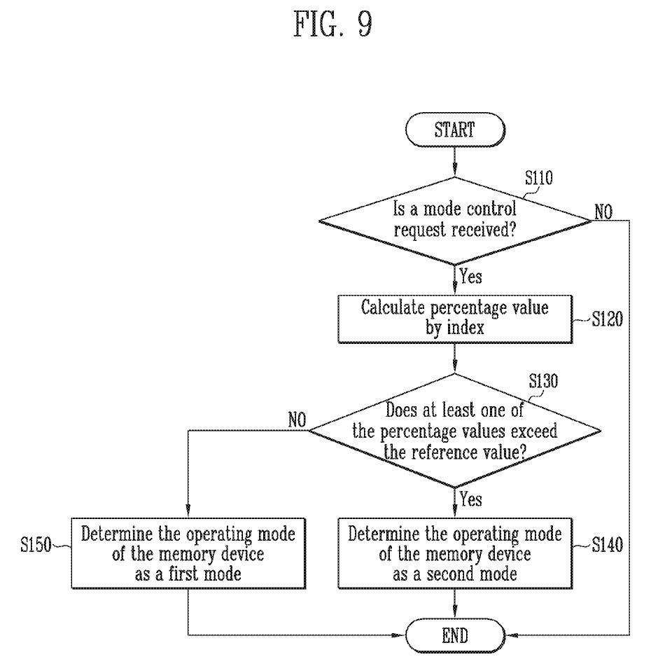

FIG. 9 is a flowchart illustrating a mode determination operation of the locality garbage collection controller 112.

In FIG. 9, the mode determination operation of the mode control operation performed by the locality garbage collection controller 112 of FIG. 2 is illustrated.

At operation S110, the locality garbage collection controller 112 may determine whether a mode control request is received from the FTL 131. When the locality garbage collection controller 112 receives the mode control request, the locality garbage collection controller 112 may perform operation S120. When the locality garbage collection controller 112 does not receive the mode control request, the locality garbage collection controller 112 might not perform the mode determination operation.

In embodiments, prior to the operation S110, the counter 111 of FIG. 2 may generate a count table and increase a count of an index corresponding to a write command received from a host.

At the operation S120, the locality garbage collection controller 112 may calculate a percentage value for each index based on the count table.

At operation S130, the locality garbage collection controller 112 may determine whether at least one of the percentage values exceeds a reference value. When at least one of the percentage values exceeds the reference value, the locality garbage collection controller 112 may perform operation S140. When none of the percentage values exceed the reference value, the locality garbage collection controller 112 may perform operation S150.

At the operation S140, the locality garbage collection controller 112 may determine the operation mode of the memory device 200 to be the second mode.

At the operation S150, the locality garbage collection controller 112 may determine the operation mode of the memory device 200 to be the first mode.

Referring to FIG. 9, it is shown that the locality garbage collection controller 112 performs the mode determination operation once, but the present disclosure is not limited thereto, and the locality garbage collection controller 112 may periodically repeat the operations S120 to S150 after receiving the mode control request from the FTL 131. For example, after executing the operation S140 or the operation S150, the process may return to the operation S120 within a same time period, based, for example, on a predetermined factor.

In embodiments, the locality garbage collection controller 112 may perform the operations S120 to S150 each time the count table is updated, or may perform the operations S120 to S150 every first reference period.

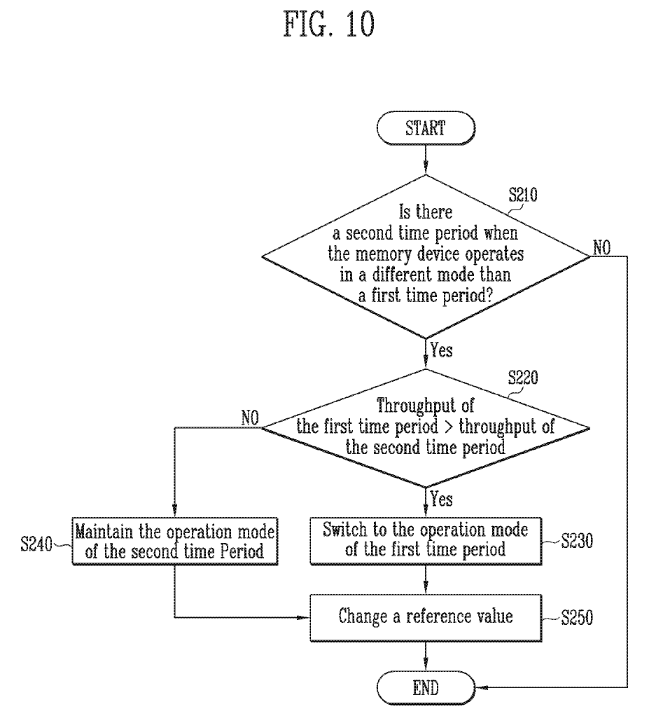

FIG. 10 is a flowchart illustrating a mode switching operation of the locality garbage collection controller 112.

In FIG. 10, the mode switching operation of the mode control operation performed by the locality garbage collection controller 112 of FIG. 2 is described.

At operation S210, the locality garbage collection controller 112 may check whether there is a second time period during which the memory device 200 operates in an operation mode which is different from the operation mode during a first time period.

When there is the second time period during which the memory device 200 operates in a different operation mode from the first time period, the locality garbage collection controller 112 may perform operation S220. When there is no second time period during which the memory device 200 operates in a different operation mode from the first time period, the locality garbage collection controller 112 might not perform the mode switching operation.

For example, referring to FIG. 7, at one time point after the time point t3, the locality garbage collection controller 112 may perform the mode switching operation. At one time point in the second time period P2 between the time point t2 and the time point t3, the locality garbage collection controller 112 might not perform the mode switching operation.

At the operation S220, the locality garbage collection controller 112 may determine whether a throughput during a first time period is greater than a throughput during a second time period. When the throughput during the first time period is greater than the throughput during the second time period, the locality garbage collection controller 112 may perform operation S230. When the throughput during the first time period is not greater than the throughput during the second time period, the locality garbage collection controller 112 may perform operation S240.

At the operation S230, the locality garbage collection controller 112 may switch the operation mode of the memory device 200 to the operation mode during the first time period.

At the operation S240, the locality garbage collection controller 112 may maintain the operation mode of the memory device 200 as the operation mode during the second time period.

At operation S250, the locality garbage collection controller 112 may change a reference value. In embodiments, when the switched operation mode is the second mode or the maintained operation mode is the second mode, the reference value may be decreased. When the switched operation mode is the first mode or the maintained operation mode is the first mode, the reference value may be increased.

Based on the changed reference value at the operation S250, the locality garbage collection controller 112 may perform the mode determination operation described with reference to FIG. 9.

Referring to FIG. 10, it is shown that the locality garbage collection controller 112 performs the mode switching operation once, but the present disclosure is not limited thereto, and when there is the second time period during which the memory device 200 operates in the operation mode which is different from the operation mode during the first time period, the locality garbage collection controller 112 may thereafter periodically repeat the operations S220 to S250.

Referring to FIGS. 9 and 10, the locality garbage collection controller 112 may first perform the mode determination operation of the mode control operation once, and then may perform the mode determination operation and the mode switching operation in parallel.

In embodiments, after a mode control request is received, the mode determination operation may be performed each time the count table is updated, or may be performed periodically every first reference period. The mode switching operation may be performed periodically every second reference period, when there is the second time period during which the memory device 200 operates in the operation mode which is different from the operation mode during the first time period. The first reference period and the second reference period may be values received by the host 11 of FIGS. 1 and 2, stored in the memory device 200 of FIG. 2, or stored in the ROM 140 of FIG. 2.

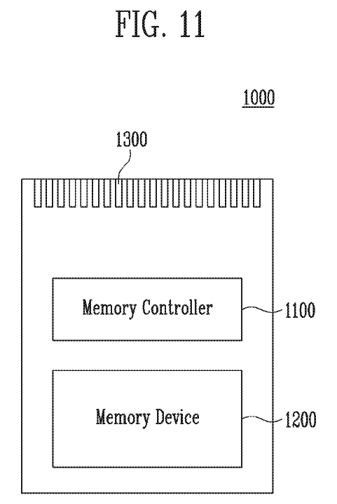

FIG. 11 is a block diagram illustrating a memory card system 1000 to which a storage device according to embodiments of the present disclosure is applied. Referring to FIG. 11, the memory card system 1000 may include a memory controller 1100, a memory device 1200, and a connector 1300.

The memory controller 1100 may be coupled to the memory device 1200. The memory controller 1100 may be configured to access the memory device 1200. For example, the memory controller 1100 may be configured to control read, write, erase, and background operations of the memory device 1200. The memory controller 1100 may be configured to provide an interface between the memory device 1200 and a host. The memory controller 1100 may be configured to drive firmware for controlling the memory device 1200. The memory device 1200 may be implemented in the same manner as the memory device 200 described with reference to FIG. 1.

For example, the memory controller 1100 may include components such as Random Access Memory (RAM), a processing unit, a host interface, a memory interface, and an error correction circuit.

The memory controller 1100 may communicate with an external device via the connector 1300. The memory controller 1100 may communicate with an external device (e.g., the host) based on a specific communication protocol. For example, the memory controller 1100 may communicate with the external device through at least one of various communication protocols such as a Universal Serial Bus (USB), a Multi-Media Card (MMC), an embedded MMC (eMMC), a Peripheral Component Interconnect (PCI), PCI-express (PCI-e), Advanced Technology Attachment (ATA), Serial-ATA (SATA), Parallel-ATA (PATA), a Small Computer System Interface (SCSI), an Enhanced Small Disk Interface (ESDI), Integrated Drive Electronics (IDE), Firewire, Universal Flash Storage (UFS), Wi-Fi, Bluetooth, and Non-Volatile Memory express (NVMe). For example, the connector 1300 may be defined by at least one of the various communication protocols described above.

For example, the memory device 1200 may be embodied as one of various non-volatile memory elements, such as Electrically Erasable and Programmable ROM (EEPROM), a NAND flash memory, a NOR flash memory, Phase-change RAM (PRAM), Resistive RAM (ReRAM), Ferroelectric RAM (FRAM), and Spin-Transfer Torque Magnetic RAM (STT-MRAM).

The memory controller 1100 and the memory device 1200 may be integrated into a single semiconductor device to form a memory card. For example, the memory controller 1100 and the memory device 1200 may be integrated into a single semiconductor device to form a memory card, such as a Personal Computer Memory Card International Association (PCMCIA), a Compact Flash (CF) card, a smart media card (SM, SMC), a memory stick, a multimedia card (MMC, RS-MMC, MMCmicro, eMMC), an SD card (SD, miniSD, microSD, SDHC), or Universal Flash Storage (UFS).

The memory controller 1100 may perform the mode control operation described with respect to FIGS. 1-10.

For example, the memory controller 1100 may control a garbage collection operation mode of the memory device 1200. The memory controller 1100 may generate a count table which includes counts corresponding to indices which group a plurality of logical page numbers in units of data of a specific size, and may increase a count of an index corresponding to a write command received from the host.

The memory controller 1100 may calculate percentage values corresponding to the indices based on the counts, and may control the garbage collection operation mode of the memory device 1200 based on the percentage values.

Further, when there is a second time period during which the memory device 1200 operates in a mode different from the garbage collection operation mode during a first time period, the memory controller 1100 may compare first throughput of the memory device 1200 during the first time period to second throughput of the memory device 1200 during the second time period.

When the first throughput is less than the second throughput, the memory controller 1100 may maintain the garbage collection operation mode during a third time period following the second time period the same as the garbage collection operation mode during the second time period. When the first throughput is greater than the second throughput, the memory controller 1100 may switch the garbage collection operation mode during the third time period to be the same as the garbage collection operation mode during the first time period.

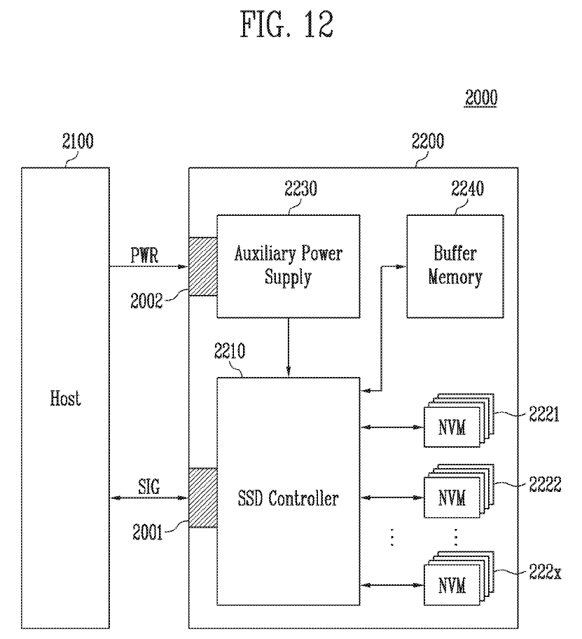

FIG. 12 is a block diagram illustrating a Solid State Drive (SSD) system 2000 to which a storage device according to embodiments of the present disclosure is applied.

Referring to FIG. 12, the SSD system 2000 may include a host 2100 and an SSD 2200. The SSD 2200 may send and receive a signal SIG to and from the host 2100 via a signal connector 2001 and receive power PWR via a power connector 2002. The SSD 2200 may include an SSD controller 2210, a plurality of flash memories 2221 to 222x, an auxiliary power supply 2230, and a buffer memory 2240. x is a natural number greater than 1.

According to embodiments, the SSD controller 2210 may perform the functions of the memory controller 100 described with reference to FIGS. 1-10. For example, the SSD controller 2210 may control a garbage collection operation mode of each of the plurality of flash memories 2221 to 222x.

The SSD controller 2210 may generate a count table which includes counts corresponding to indices which group a plurality of logical page numbers in units of data of a specific size, and may increase a count of an index corresponding to a write command received from the host 2100.

The SSD controller 2210 may calculate percentage values corresponding to the indices based on the counts, and may control the garbage collection operation mode of each of the plurality of flash memories 2221 to 222x based on the percentage values.

Further, when there is a second time period during which the plurality of flash memories 2221 to 222x operate in a different mode than the garbage collection operation mode during a first time period, the SSD controller 2210 may compare first throughput of the plurality of flash memories 2221 to 222x during the first time period to second throughput of the plurality of flash memories 2221 to 222x during the second time period.

When the first throughput is less than the second throughput, the SSD controller 2210 may maintain the garbage collection operation mode during a third time period following the second time period the same as the garbage collection operation mode during the second time period. When the first throughput is greater than the second throughput, the SSD controller 2210 may switch the garbage collection operation mode during the third time period to be the same as the garbage collection operation mode during the first time period.

The SSD controller 2210 may control the plurality of flash memories 2221 to 222x in response to the signal SIG received from the host 2100. For example, the signal SIG may be based on an interface of the host 2100 and the SSD 2200. For example, the signal SIG may be defined by at least one of communication standards or interfaces, such as Universal Serial Bus (USB), Multi-Media Card (MMC), embedded MMC (eMMC), Peripheral Component Interconnect (PCI), PCI-express (PCI-e), Advanced Technology Attachment (ATA), Serial-ATA (SATA), Parallel-ATA (PATA), Small Computer System Interface (SCSI), Enhanced Small Disk Interface (ESDI), Integrated Drive Electronics (IDE), Firewire, Universal Flash Storage (UFS), Wi-Fi, Bluetooth, and Non-Volatile Memory express (NVMe) interfaces.

The auxiliary power supply 2230 may be coupled to the host 2100 via the power connector 2002. The auxiliary power supply 2230 may receive the power PWR from the host 2100 and may be charged. The auxiliary power supply 2230 may provide power of the SSD 2200 when the power supply from the host 2100 is not smooth. For example, the auxiliary power supply 2230 may be located within the SSD 2200 or may be located outside the SSD 2200. For example, the auxiliary power supply 2230 may be located on a main board and may provide auxiliary power to the SSD 2200.

The buffer memory 2240 may operate as a buffer memory for the SSD 2200. For example, the buffer memory 2240 may temporarily store data received from the host 2100 or data received from the plurality of flash memories 2221 to 222x, or may temporarily store metadata (e.g., a mapping table) of the plurality of flash memories 2221 to 222x. The buffer memory 2240 may include a volatile memory, such as DRAM, Synchronous Dynamic Random Access Memory (SDRAM), Double Data Rate (DDR) SDRAM, Low-Power Double Data Rate (LPDDR) SDRAM, or graphics random access memory (GRAM), or a non-volatile memory, such as FRAM, ReRAM, STT-MRAM, or PRAM.

The embodiments disclosed herein are illustrative of the technical spirit of the present disclosure, not limiting the technical spirit of the present disclosure, and the scope of the technical spirit of the present disclosure is not limited by these embodiments. The scope of protection of this disclosure shall be construed by the appended claims, and all technical spirits within an equivalent scope shall be construed to be included within the scope of this disclosure.

Embodiments of the present disclosure may provide a storage device including a memory controller which dynamically determines whether to perform a locality garbage collection operation by taking into account an actual workload of a memory device, and therefore does not perform an unnecessary locality garbage collection operation and increases the efficiency of a garbage collection operation, and a method of operating the memory controller.

What is claimed is:

1. A storage device comprising:
a memory device including a plurality of memory blocks; and
a memory controller configured to control a garbage collection operation mode of the memory device,
wherein the memory controller comprises:
a host interface layer (HIL) configured to manage, based on a plurality of logical page numbers, a plurality of logical pages respectively mapped to the plurality of memory blocks;
a counter configured to generate a count table including counts corresponding to indices which group the plurality of logical page numbers in units of data of a specific size, and increase, when a write command is received from a host, a count of an index corresponding to the write command; and
a locality garbage collection controller configured to calculate percentage values corresponding to the indices based on the counts, and determine, based on the percentage values, the garbage collection operation mode to be a mode in which a garbage collection operation taking locality into account is performed.

2. The storage device of claim 1, wherein the locality garbage collection controller is configured to:
determine, when the percentage values do not exceed a reference value, the garbage collection operation mode to be a first mode in which a garbage collection operation which does not take the locality into account is performed; and
determine, when at least one of the percentage values exceeds the reference value, the garbage collection operation mode to be a second mode in which a garbage collection operation which takes the locality into account is performed.

3. The storage device of claim 2, wherein the second mode is an operation mode in which garbage collection is performed by excluding recently invalidated logical memory blocks from selection of victim blocks for the garbage collection operation.

4. The storage device of claim 2, wherein, when the HIL receives the write command from the host:
the HIL is configured to translate a logical block address corresponding to the write command to a logical page number; and
the counter is configured to increase a count of an index corresponding to the logical page number obtained by translating the logical block address.

5. The storage device of claim 4,
wherein the memory controller further comprises a Flash Translation Layer (FTL), and
wherein, when the FTL determines that a number of memory blocks managed by the FTL remains constant:
the FTL is configured to send a mode control request to the locality garbage collection controller; and
the locality garbage collection controller is configured to, after receiving the mode control request, periodically perform a mode determination operation for determining the garbage collection operation mode to be one of the first mode and the second mode based on the percentage values.

6. The storage device of claim 5, wherein the locality garbage collection controller is configured to perform the mode determination operation when the count table is updated.

7. The storage device of claim 6, wherein the locality garbage collection controller is configured to periodically perform the mode determination operation according to a first reference period.

8. The storage device of claim 5, wherein the locality garbage collection controller is configured to:
compare, when there is a second time period during which the memory device operates in a garbage collection operation mode different from a garbage collection operation mode of a first time period, a first throughput of the memory device during the first time period with a second throughput of the memory device during the second time period, the second time period following the first time period; and
maintain, when the first throughput is less than the second throughput, a garbage collection operation mode during a third time period after the second time period to be identical to the garbage collection operation mode of the second time period.

9. The storage device of claim 8, wherein, when the first throughput is greater than the second throughput, the locality garbage collection controller is configured to switch the garbage collection operation mode of the third time period to be identical to the garbage collection operation mode of the first time period.

10. The storage device of claim 9, wherein:
the first throughput is a Direct Memory Access (DMA) count of the memory device per unit of time during the first time period; and
the second throughput is a DMA count of the memory device per unit of time during the second time period.

11. The storage device of claim 9, wherein the locality garbage collection controller is configured to:
increase the reference value when the garbage collection operation mode during the third time period is the first mode; and
decrease the reference value when the garbage collection operation mode during the third time period is the second mode.

12. The storage device of claim 11, wherein, when there are the first time period and the second time period, the locality garbage collection controller is configured to periodically perform a mode switching operation for determining the garbage collection operation mode based on the first throughput and the second throughput.

13. The storage device of claim 12, wherein the locality garbage collection controller is configured to periodically perform the mode switching operation according to a second reference period.

14. A method of controlling a garbage collection operation mode of a memory device including a plurality of memory blocks, the method comprising:
generating a count table including counts corresponding to indices which group a plurality of logical page numbers in units of data of a specific size;
increasing, when a write command is received from a host, a count of an index corresponding to the write command;
calculating percentage values corresponding to the indices based on the counts; and
determining, based on the percentage values, the garbage collection operation mode to be a mode in which a garbage collection operation taking locality into account is performed.

15. The method of claim 14, wherein calculating the percentage values includes calculating the percentage values when a number of memory blocks managed by the memory controller remains constant.

16. The method of claim 15, wherein determining the garbage collection operation mode comprises:
comparing the percentage values with a reference value;
determining, when the percentage values do not exceed the reference value, the garbage collection operation mode to be a first mode in which a garbage collection operation which does not take the locality into account is performed; and
determining, when at least one of the percentage values exceeds the reference value, the garbage collection operation mode to be a second mode in which a garbage collection operation which takes the locality into account is performed.

17. The method of claim 16, further comprising:
comparing, when there is a second time period during which the memory device operates in a second garbage collection operation mode different from a first garbage collection operation mode of a first time period, a first throughput of the memory device during the first time period with a second throughput of the memory device during the second time period, the second time period following the first time period; and
maintaining, when the first throughput is less than the second throughput, a garbage collection operation mode during a third time period after the second time period to be identical to the garbage collection operation mode of the second time period.

18. The method of claim 17, further comprising switching, when the first throughput is greater than the second throughput, the garbage collection operation mode of the third time period to be identical to the garbage collection operation mode of the first time period.

19. The method of claim 18, further comprising increasing the reference value when the garbage collection operation mode during the third time period is the first mode.

20. The method of claim 18, further comprising decreasing the reference value when the garbage collection operation mode during the third time period is the second mode.
